(19) United States
(12) Patent Application Publication
(10) Pub. No.: US 2023/0080683 A1
(43) Pub. Date: Mar. 16, 2023

(54) READILY BIODEGRADABLE REFRIGERANT GEL FOR COLD PACKS

(71) Applicant: Minus Works LLC, Islandia, NY (US)

(72) Inventor: Benjamin Wyckoff SHORE, Islandia, NY (US)

(21) Appl. No.: 17/903,246

(22) Filed: Sep. 6, 2022

Related U.S. Application Data
(60) Provisional application No. 63/241,574, filed on Sep. 8, 2021.

(51) Int. Cl. C09K 5/06; B65D 81/18

(52) U.S. Cl. CPC C09K 5/066; B65D 81/18

(57) ABSTRACT

A readily biodegradable refrigerant gel in a cold pack is provided. The readily biodegradable refrigerant gel is contained within a high barrier container. The refrigerant gel includes water, at least one preservative, a pH reducer, and a thickener. The refrigerant gel is shelf-stable for at least 12 months and readily biodegradable upon disposal.

### CROSS-REFERENCE TO RELATED APPLICATIONS

This application claims priority to and the benefit of the filing date of U.S. Provisional Application No. 63/241,574, filed on Sep. 8, 2021, which is hereby incorporated by reference herein in its entirety.

### TECHNICAL FIELD

The present disclosure generally relates to novel readily biodegradable refrigerant gel formulations used in cold packs for keeping perishable or temperature sensitive items in specified temperature ranges. Ready biodegradability may make for sustainable methods of disposal at the end of a cold pack products' useful life. More specifically, the present disclosure relates to novel refrigerant gel formulations that are shelf-stable and readily biodegradable upon disposal.

### BACKGROUND

Unless otherwise indicated herein, the materials described in this section are not prior art to the claims in this application and are not admitted being prior art by inclusion in this section.

The proliferation of eCommerce has resulted in a rapid rise of online generated deliveries and shipments. This trend may also be driving the increased generation of packaging materials and packaging material waste. The shipping of perishables and temperature sensitive items may require more packaging than standard products (i.e., insulation, refrigerant cold packs, box liners) and thus may generate even more waste. As grocery stores and pharmacies move more business online, as well as the rise in meal-kits and curated food boxes, a sharp rise in packaging waste may be further exacerbated.

Packaging waste and the use of non-renewable, non-recyclable materials may be especially prevalent in the cold pack industry, a subset of the packaging material industry. Cold packs may be passive refrigerants used to keep payloads within specified temperature ranges. There may be several different forms of cold packs used for shipping perishables including gel packs. A gel pack may consist of a viscous gel, such as a hydrogel, contained in a pouch made with plastic film. Cold packs may be frozen for a period of time before use. A cold pack may have a high latent heat of fusion to allow the cold pack to absorb a large quantity of heat or energy per unit mass so that the cold pack may stay colder for a longer period of time, thus keeping the payload cooler for a longer period of time.

Typical cold packs may be manufactured with Sodium Polyacrylate (a salt of acrylic acid) as the chief component of the hydrogel. Sodium Polyacrylate may also be referred to as superabsorbent polymer (SAP). Sodium Polyacrylate may be inexpensive, mix rapidly in water, and have good fluid retention properties. Sodium Polyacrylate may also be derived from non-renewable petroleum products and may not be biodegradable. A gel formed from Sodium Polyacrylate may trap fresh water that then cannot be recycled back into the ecosystem.

A decrease in packaging waste and the use of renewable, recyclable materials are desired in the packaging material industry, and in particular, in the cold pack industry.

### SUMMARY

Existing challenges associated with the foregoing, as well as other challenges, are overcome by the presently disclosed readily biodegradable refrigerant gel for cold packs.

One embodiment of the present disclosure is a readily biodegradable refrigerant gel for cold packs.

The present disclosure comprises a cold pack with readily biodegradable refrigerant gel contained in a high barrier material. The refrigerant gel is composed of water, a non-ionic, biodegradable thickening agent, at least one preservative which may target a large microbial spectrum including the anerobic type, and a pH reducer. The refrigerant gel is able to meet the standard for Ready Biodegradability as defined by OECD 301B by achieving 100% biodegradation within 28 days of contact with an aerobic environment, with the majority of the biodegradation occurring within a 10 day period within the 28 days. The biodegradation can start whenever the cold pack is ready for disposal by making a cut or opening in the high barrier material which allows oxygen to come in contact with the gel. Until the cold pack is ready for disposal, it will stay shelf-stable for at least 12 months.

In aspects, the at least one preservative is about 0.25% by weight relative to the water.

In aspects, the at least one preservative is selected from potassium sorbate, sodium benzoate, salts of sorbic acid and benzoic acid, sodium nitrate and other salts of nitric acid, calcium propionate and salts of propionic acid, sodium bisulfite, potassium bisulfite, nisin peptide, citric acid, acetic acid, copper sulfate, aluminum sulfate, and combinations thereof

In aspects, the at least one preservative is a first preservative, and the refrigerant gel further comprises an optional second preservative.

In aspects, the optional second preservative is about 0.25% by weight relative to the water.

In aspects, the optional second preservative is selected from sodium benzoate, potassium sorbate, salts of sorbic acid and benzoic acid, sodium nitrate and other salts of nitric acid, calcium propionate and salts of propionic acid, sodium bisulfite, potassium bisulfite, nisin peptide, citric acid, acetic acid, copper sulfate, and combinations thereof.

In aspects, the pH reducer is about 0.05% by weight relative to the water.

In aspects, the pH reducer is selected from citric acid, acetic acid, hydrochloric acid, muriatic acid, phosphoric acid, sulfuric acid, carbonic acid, nitric acid, and combinations thereof.

In aspects, the thickening agent is about 0.50% to about 2.5% by weight relative to the water.

In aspects, the high barrier container includes Low Density Polyethylene (LDPE) film laminated to Polyamide (PA) film (Nylon), LDPE, Polypropylene (PP), Polyamide (PA), Polyester (PET), High Density Polyethylene (HDPE), Polylactic Acid (PLA), Polyvinyl Alcohol (PVA/PVOH), Cellulose, Cellophane, Polyethylene Vinyl Acetate (PEVA), Cellulose Di-acetate, Paper, and combinations thereof.

The present disclosure also provides methods of forming a cold pack with readily biodegradable refrigerant gel. The methods include depositing a predetermined amount of water into a chamber, heating the water, adding at least one preservative to the water to form a mixture, adding a pH reducer to the mixture to form a first composition, adding a thickening agent to the first composition, mixing the thickening agent into the first composition to form the readily biodegradable refrigerant gel, metering the readily biodegradable refrigerant gel into a high barrier container, and sealing the high barrier container to form the cold pack.

In aspects, the water is heated to over 90° F.

Another embodiment of the present disclosure includes a readily biodegradable refrigerant gel in a cold pack. The refrigerant gel is contained within a high barrier container, and includes water, potassium sorbate, citric acid, and Guar Gum. The refrigerant gel is readily biodegradable and shelf-stable for at least 12 months.

In aspects, the refrigerant gel further includes sodium benzoate.

In aspects, the high barrier container includes Low Density Polyethylene (LDPE) film laminated to Polyamide (PA) film (Nylon).

### BRIEF DESCRIPTION OF THE FIGURES:

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system or method that can be utilized to produce a cold pack with readily biodegradable refrigerant gel according to the present disclosure;

FIG. 2 is a rear view of a cold pack with readily biodegradable refrigerant gel according to the present disclosure;

FIG. 3 is a front view of a system or method for preparing a cold pack with readily biodegradable refrigerant gel for disposal according to the present disclosure; and

FIG. 4 is a graphical representation of a percentage of biodegradation of a cold pack with readily biodegradable refrigerant gel over time according to the present disclosure.

### DETAILED DESCRIPTION

The terminology used herein is for the purpose of describing particular embodiments only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

Nevertheless, the specification and claims should be read with the understanding that such combinations are entirely within the scope of the disclosure and the claims.

Novel methods for producing cold packs with rapidly biodegradable refrigerant gel are discussed herein. In the following description, for purposes of explanation, numerous specific details are set forth in order to provide a thorough understanding of the present disclosure. It will be evident, however, to one skilled in the art that the present disclosure may be practiced without these specific details.

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure may comprise a cold pack with readily biodegradable refrigerant gel contained in a high barrier material. Readily biodegradable material may be defined by OECD 301B testing methodology. A high barrier material may have an Oxygen Transmission Rate of up to about 7.0 cc/100 in²/day per ASTM D3985, and a Moisture Vapor Transmission Rate of up to about 1.0 g/100 in²/day per ASTM F1249. In an example, a high barrier material may have an Oxygen Transmission Rate of about 3.3 cc/100 in²/day per ASTM D3985, and a Moisture Vapor Transmission Rate of about 0.4 g/100 in²/day per ASTM F1249. The refrigerant gel may be composed of water, a non-ionic, biodegradable thickening agent and preservatives which may combine to target a large microbial spectrum including the anerobic type. The formed refrigerant gel may be able to achieve the Ready Biodegradability standard as per Organization for Economic Co-operation and Development (OECD) 301B and attain 100% biodegradation within 28 days of contact with an aerobic environment, with the majority of the biodegradation occurring within a 10 day period. The biodegradation may start whenever the cold pack is ready for disposal by making a cut or opening in the high barrier material to allow oxygen to come in contact with the gel material. While the high barrier material is intact, the cold pack may remain shelf-stable for at least 12 months.

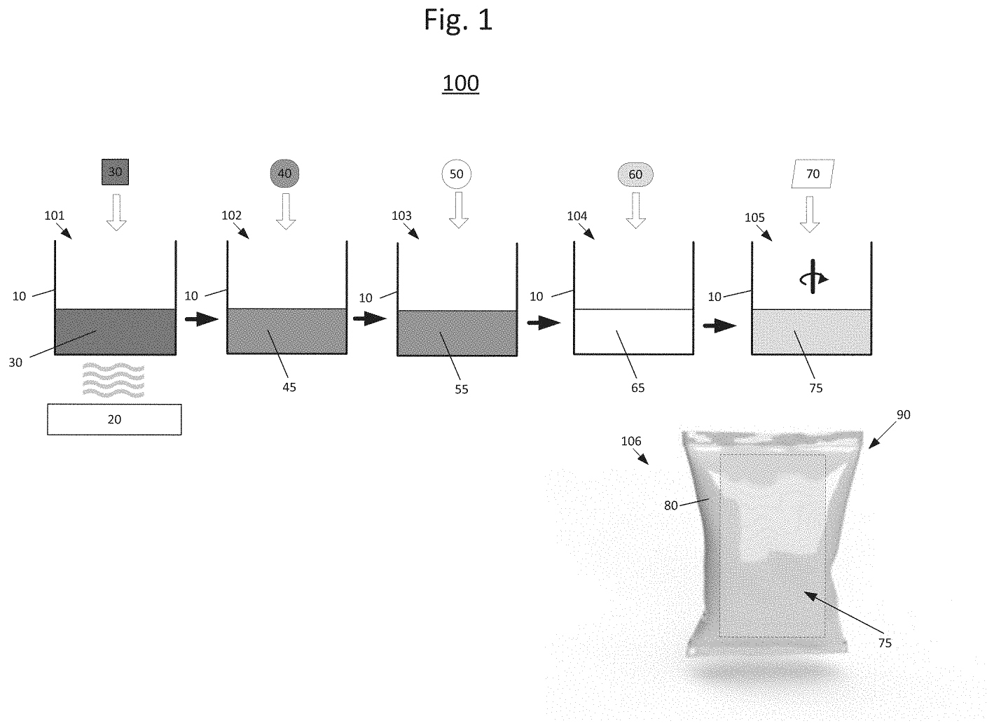

FIG. 1 illustrates an example system or method that can be utilized to produce a cold pack with readily biodegradable refrigerant gel, arranged in accordance with at least some embodiments presented herein.

System 100 may include a chamber 10 and a heater 20 proximate to chamber 10. At 101, water 30 may be deposited into chamber 10. In embodiments, the water 30 may be heated by heater 20. Water 30 may be heated to over 90° F., in embodiments to over 100° F. Heating of water 30 may assist in hydration of additionally added components as well as offer some biocidal action akin to pasteurization to reduce the initial microbial load.

At 102, a preservative 40 may be added and mixed with water 30 to generate combination 45. Preservative 40 may be about 0.25% by weight relative to water 30. Preservative 40 may target a certain spectrum of microbe. In embodiments, preservative 40 may be potassium sorbate, although other preservatives may be contemplated such as for example, sodium benzoate, salts of sorbic acid and benzoic acid, sodium nitrate and other salts of nitric acid, calcium propionate and salts of propionic acid, sodium bisulfite, potassium bisulfite, nisin peptide, citric acid, acetic acid, copper sulfate, and combinations thereof

At 103, a second preservative 50 may be added and mixed with mixture 45 to generate combination 55. Second preservative 50 may be about 0.25% by weight relative to water 30. Preservative 50 may target a certain spectrum of microbe, may act synergistically with a thickener to enhance viscosity, and may act as a nucleating agent to achieve a faster freeze. In embodiments, preservative 50 may be sodium benzoate, although other preservatives may be contemplated such as for example potassium sorbate, salts of sorbic acid and benzoic acid, sodium nitrate and other salts of nitric acid, calcium propionate and salts of propionic acid, sodium bisulfite, potassium bisulfite, nisin peptide, citric acid, acetic acid, copper sulfate, and combinations thereof. In embodiments, additional preservatives may also be added to combination 55 to supplement or supplant those described above, including other salts of sorbic acid and benzoic acid, sodium nitrate and other salts of nitric acid, calcium propionate and salts of propionic acid, sodium bisulfite, potassium bisulfite, nisin peptide, citric acid, acetic acid, copper sulfate, and combinations thereof

At 104, a pH reducer 60 may be added and mixed with combination 55 to generate combination 65. PH reducer 60 may be about 0.05% by weight relative to water 30 or an amount required to reduce a pH of combination 65 within the range of about 4.5 to about 6.0. In embodiments, the pH may be reduced to a range of about 5.0 to about 5.6. Reducing the pH of combination 65 may enhance an effectiveness of preservative 40 and preservative 50. In embodiments, pH reducer 60 may be an acid. In embodiments, pH reducer 60 may be citric acid, in other embodiments, pH reducer may be acetic acid. Other pH reducers may be contemplated such as, for example hydrochloric acid, muriatic acid, phosphoric acid, sulfuric acid, carbonic acid, nitric acid, or combinations thereof.

Process steps shown at 102, 103, and 104 may be interchangeable, may be performed in any order, or may be performed concurrently.

At 105, a thickening agent 70 may be added to combination 65 to generate gel 75. Thickening agent 70 may be about 0.50% to about 2.5% by weight relative to water 30. Thickening agent 70 may be a powder and may be mixed into combination 65 with agitation. Thickening agent 70 may be mixed into combination 65 for a period of time of about 5 to about 10 minutes to ensure full dissolution of powdered thickening agent 70. Liquified thickening agents may also be contemplated.

A method of dispersing powdered thickening agent 70 into water 30 as known in the art may be used. Thickening agent 70 may be non-ionic and may not be affected by the lowered pH. Thickening agent 70 may be readily biodegradable. Thickening agent 70 may limit a size of ice crystals which may form in a gel and may create a more uniform lattice structure in a frozen gel pack, which in turn requires more energy to melt the frozen gel pack, thereby improving its performance and ability to absorb heat. In embodiments, thickening agent 70 may be Guar Gum. In other embodiments, thickening agent 70 may be a Hydrocolloid such as Xanthan Gum, Pectin, Gum Arabica, Locust Bean, Tara Gum, Gum Tragacanth, and Konjac mannan. In still further embodiments, thickening agent 70 may be a Cellulose product that does not have a heavy enzymatic resistance such as Methyl Cellulose (MC), Hydroxy Propyl Methyl Cellulose (HPMC), and Carboxymethyl cellulose (CMC). In still further embodiments, thickening agent 70 may be Starch Grafted acrylamide co-polymer and Polyglutamic Acid.

At 106, gel 75 may be metered into high barrier containers 80 that may be subsequently sealed to form a cold pack with readily biodegradable refrigerant gel contained in a high barrier material 90. The high barrier containers 80 may be filled by a process known in the art such as for example, the vertical form fill seal process. High barrier containers 80 may be made from high barrier material as defined by Oxygen Transmission Rate and Moisture Vapor Transmission Rate. In embodiments, a high barrier material may have an Oxygen Transmission Rate of up to about 7.0 cc/100 in²/day per ASTM D3985, and a Moisture Vapor Transmission Rate of up to about 1.0 g/100 in²/day per ASTM F1249. In embodiments, a high barrier material may have an Oxygen Transmission Rate of about 3.3 cc/100 in²/day per ASTM D3985, and a Moisture Vapor Transmission Rate of about 0.4 g/100 in²/day per ASTM F1249. In embodiments, high barrier containers 80 may be made from Low Density Polyethylene (LDPE) film laminated to Polyamide (PA) film (Nylon), although other materials are contemplated such as for example monomaterials, coextrusions, and laminates comprised of any combination of the following materials: LDPE, Polypropylene (PP), Polyamide (PA), Polyester (PET), High Density Polyethylene (HDPE), Polylactic Acid (PLA), Polyvinyl Alcohol (PVA/PVOH), Cellulose, Cellophane, Polyethylene Vinyl Acetate (PEVA), Cellulose Di-acetate, and Paper. High barrier container 80 may prevent oxygen from contacting the gel 75 contained within high barrier container 80 and may extend a shelf life of cold pack 90. Cold pack with readily biodegradable refrigerant gel contained in a high barrier material 90 may be frozen and used to keep perishables at refrigerated or frozen temperatures.

The above process may be performed in batches of large volume as long as the weight percentages are consistent.

Gel 75 may be a readily biodegradable refrigerant gel and may comprise water, at least one preservative, a pH reducer and a thickener. In embodiments, readily biodegradable refrigerant gel 75 includes water, potassium sorbate, sodium benzoate, citric acid, and Guar Gum. In other embodiments, readily biodegradable refrigerant gel 75 includes water, about 0.25% potassium sorbate by weight relative to the water, about 0.25% sodium benzoate by weight relative to the water, about 0.05% citric acid by weight relative to the water, and about 0.50% guar gum by weight relative to the water.

As a representative example, for example, in embodiments, 350 gallons of readily biodegradable refrigerant gel 75 may comprise about 2,919 lbs. of water, about 7.3 lbs. of potassium sorbate, about 7.3 lbs. of sodium benzoate, about 1.5 lbs. of citric acid, and about 14.6 lbs. of guar gum.

TABLE 1
Example Readily Biodegradable refrigerant gel - 350 gallon batch

| Component | Percent of Water | Weight (lbs.) |
|---|---|---|
| Water | 100 | 2919.000 |
| Potassium Sorbate | 0.250 | 7.2975 |
| Sodium Benzoate | 0.250 | 7.2975 |
| Citric Acid | 0.050 | 1.4595 |
| Guar Gum | 0.500 | 14.595 |

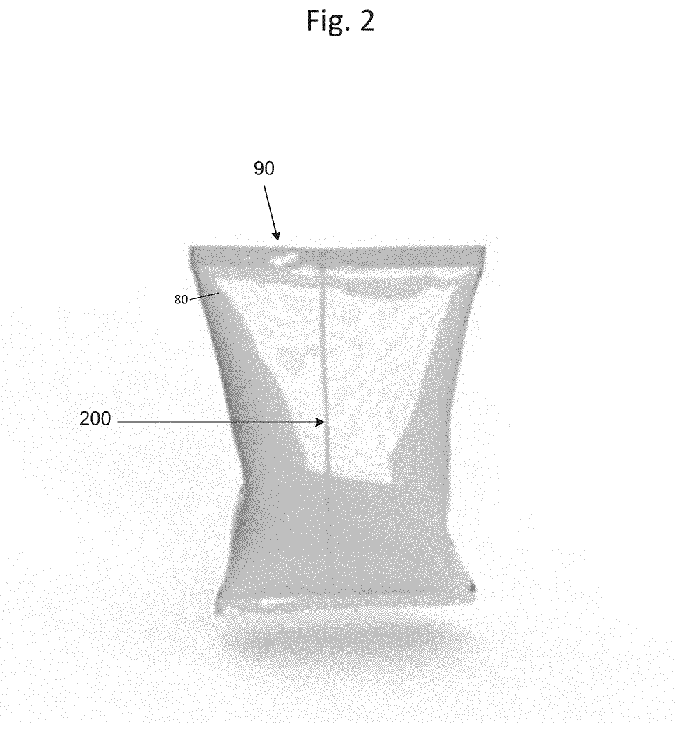

FIG. 2 is a rear view of a cold pack with readily biodegradable refrigerant gel, arranged in accordance with at least some embodiments presented herein. Those components in FIG. 2 that are labeled identically to components of FIG. 1 will not be described again for the purposes of brevity.

A vertical form fill seal process may be utilized to remove excess air from the high barrier container 80 prior to sealing high barrier container 80 by using “deflators” which contact high barrier container 80 film before the sealing jaws. As shown in FIG. 2, the back of cold pack with readily biodegradable refrigerant gel contained in a high barrier material 90 may include vertical seal 200.

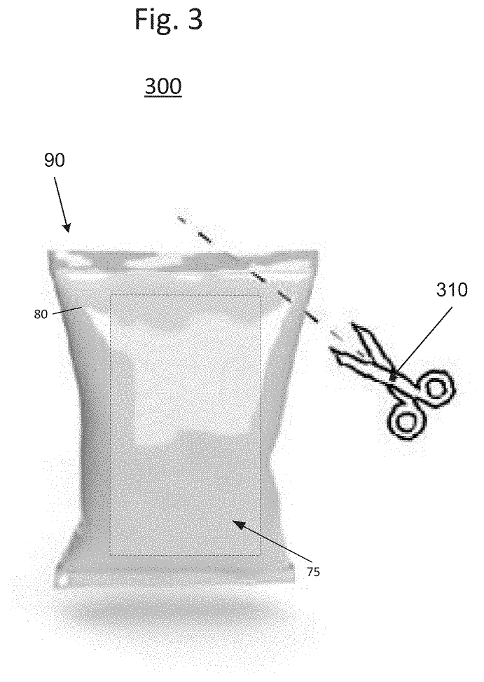

FIG. 3 is a front view of a system or method for preparing a cold pack with readily biodegradable refrigerant gel for disposal, arranged in accordance with at least some embodiments presented herein. Those components in FIG. 3 that are labeled identically to components of FIGS. 1-2 will not be described again for the purposes of brevity. System 300 may include cold pack with readily biodegradable refrigerant gel contained in a high barrier material 90 and cutting tool 310.

Once a useful life of cold pack with readily biodegradable refrigerant gel contained in a high barrier material 90 is over, the high barrier container 80 may be opened to expose the gel to an aerobic environment and start the biodegradation process. Cold pack 90 may be thawed prior to cutting, piercing or opening of high barrier container 80. Cutting, piercing or opening of high barrier container 80 with cutting tool 310 or any appropriate tool known in the art may allow oxygen to contact gel 75 within high barrier container 80. When the environment around gel 75 is changed from anaerobic to aerobic, the biodegradation process of gel 75 may commence. Cut, pierced, or opened cold pack 90 may be disposed of in normal waste streams or composted. Gel 75 may fully break down in a short period of time and may not add to the growing landfill problem.

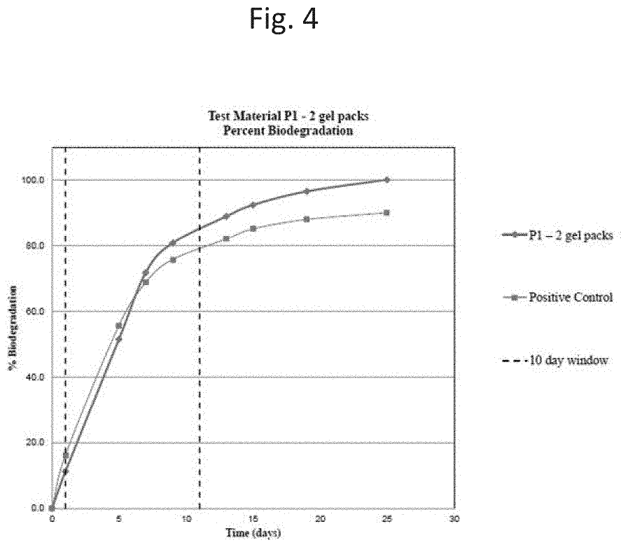

FIG. 4 is a graphical representation of a percentage of biodegradation of a cold pack with readily biodegradable refrigerant gel over time, arranged in accordance with at least some embodiments presented herein. FIG. 4 provides a graphical representation of the percentage of biodegradation of a cold pack with readily biodegradable refrigerant gel on the Y-axis and time in days on the X axis. The graph data shows the majority (about >70%) of the material of a cold pack with readily biodegradable refrigerant gel biodegrades within a 10 day period and the material fully (about 100%) biodegrades within 25 days.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

1. A readily biodegradable refrigerant gel in a cold pack comprising:
a refrigerant gel contained within a high barrier container, wherein the refrigerant gel includes:
water;
at least one preservative;
a pH reducer; and
a thickener, wherein the refrigerant gel is shelf-stable for at least 12 months and readily biodegradable upon disposal.

2. The readily biodegradable refrigerant gel of claim 1, wherein the at least one preservative is about 0.25% by weight relative to the water.

3. The readily biodegradable refrigerant gel of claim 1, wherein the at least one preservative is selected from the group consisting of potassium sorbate, sodium benzoate, salts of sorbic acid and benzoic acid, sodium nitrate and other salts of nitric acid, calcium propionate and salts of propionic acid, sodium bisulfite, potassium bisulfite, nisin peptide, citric acid, acetic acid, copper sulfate, aluminum sulfate, and combinations thereof.

4. The readily biodegradable refrigerant gel of claim 1, wherein the at least one preservative is a first preservative, and the refrigerant gel optionally further comprises a second preservative.

5. The readily biodegradable refrigerant gel of claim 4, wherein the optional second preservative is about 0.25% by weight relative to the water.

6. The readily biodegradable refrigerant gel of claim 4, wherein the optional second preservative is selected from the group consisting of sodium benzoate, potassium sorbate, salts of sorbic acid and benzoic acid, sodium nitrate and other salts of nitric acid, calcium propionate and salts of propionic acid, sodium bisulfite, potassium bisulfite, nisin peptide, citric acid, acetic acid, copper sulfate, aluminum sulfate, and combinations thereof.

7. The readily biodegradable refrigerant gel of claim 1, wherein the pH reducer is about 0.05% by weight relative to the water.

8. The readily biodegradable refrigerant gel of claim 1, wherein the pH reducer is selected from the group consisting of citric acid, acetic acid, hydrochloric acid, muriatic acid, phosphoric acid, sulfuric acid, carbonic acid, nitric acid, and combinations thereof.

9. The readily biodegradable refrigerant gel of claim 1, wherein the thickening agent is about 0.50% to about 2.5% by weight relative to the water.

10. The readily biodegradable refrigerant gel of claim 1, wherein the thickening agent is selected from the group consisting of Guar Gum, Xanthan Gum, Pectin, Gum Arabica, Locust Bean, Tara Gum, Gum Tragacanth, Konjac mannan, Methyl Cellulose (MC), Hydroxy Propyl Methyl Cellulose (HPMC), Carboxymethyl cellulose (CMC), Starch Grafted acrylamide co-polymer, Polyglutamic Acid, and combinations thereof.

11. The readily biodegradable refrigerant gel of claim 1, wherein the high barrier container includes Low Density Polyethylene (LDPE) film laminated to Polyamide (PA) film (Nylon), LDPE, Polypropylene (PP), Polyamide (PA), Polyester (PET), High Density Polyethylene (HDPE), Polylactic Acid (PLA), Polyvinyl Alcohol (PVA/PVOH), Cellulose, Cellophane, Polyethylene Vinyl Acetate (PEVA), Cellulose Di-acetate, Paper, and combinations thereof.

12. A method for making a readily biodegradable refrigerant gel in a cold pack, the method comprising:
depositing a predetermined amount of water into a chamber;
heating the water;
adding and mixing at least one preservative with the water to form a mixture;
adding and mixing a pH reducer with the mixture to form a first composition;
adding and mixing a thickening agent with the first composition to form the readily biodegradable refrigerant gel;
metering the readily biodegradable refrigerant gel into a high barrier container; and
sealing the high barrier container to form the cold pack.

13. The method of claim 12, wherein the heating includes heating the water to over 90° F.

14. The method of claim 12, wherein the at least one preservative is about 0.25% by weight relative to the water and the at least one preservative is selected from the group consisting of potassium sorbate, sodium benzoate, salts of sorbic acid and benzoic acid, sodium nitrate and other salts of nitric acid, calcium propionate and salts of propionic acid, sodium bisulfite, potassium bisulfite, nisin peptide, citric acid, acetic acid, copper sulfate, aluminum sulfate, and combinations thereof.

15. The method of claim 12, wherein the pH reducer is about 0.05% by weight relative to the water and the pH reducer is selected from the group consisting of citric acid, acetic acid, hydrochloric acid, muriatic acid, phosphoric acid, sulfuric acid, carbonic acid, nitric acid, and combinations thereof

16. The method of claim 12, wherein the thickening agent is about 0.50% to about 2.5% by weight relative to the water and the thickening agent is selected from the group consisting of Guar Gum, Xanthan Gum, Pectin, Gum Arabica, Locust Bean, Tara Gum, Gum Tragacanth, Konjac mannan, Methyl Cellulose (MC), Hydroxy Propyl Methyl Cellulose (HPMC), Carboxymethyl cellulose (CMC), Starch Grafted acrylamide co-polymer, Polyglutamic Acid, and combinations thereof.

17. The method of claim 12, wherein the high barrier container includes Low Density Polyethylene (LDPE) film laminated to Polyamide (PA) film (Nylon), LDPE, Polypropylene (PP), Polyamide (PA), Polyester (PET), High Density Polyethylene (HDPE), Polylactic Acid (PLA), Polyvinyl Alcohol (PVA/PVOH), Cellulose, Cellophane, Polyethylene Vinyl Acetate (PEVA), Cellulose Di-acetate, Paper, and combinations thereof

18. A readily biodegradable refrigerant gel in a cold pack comprising:
a refrigerant gel contained within a high barrier container, wherein the refrigerant gel includes:
water;
potassium sorbate;
citric acid; and
Guar Gum, wherein the refrigerant gel is shelf-stable for at least 12 months and readily biodegradable upon disposal.

19. The readily biodegradable refrigerant gel of claim 18, further comprising sodium benzoate.

20. The readily biodegradable refrigerant gel of claim 18, wherein the high barrier container includes Low Density Polyethylene (LDPE) film laminated to Polyamide (PA) film (Nylon).
